(19) United States
(12) Patent Application Publication
(10) Pub. No.: US 2023/0143275 A1
(43) Pub. Date: May 11, 2023

(54) SOFTWARE CLIPBOARD

(71) Applicant: GUANGDONG OPPO MOBILE TELECOMMUNICATIONS CORP., LTD., Dongguan (CN)

(72) Inventors: Edward OPARA, Dongguan (CN); Jody HUDSON-POWELL, Dongguan (CN)

(21) Appl. No.: 18/148,412

(22) Filed: Dec. 29, 2022

Related U.S. Application Data
(63) Continuation of application No. PCT/CN2020/125508, filed on Oct. 30, 2020.
(60) Provisional application No. 63/081,760, filed on Sep. 22, 2020.

(51) Int. Cl. G06F 3/0486; G06F 3/04845; G06F 3/04883; G06F 3/0482; G06F 9/54

(52) U.S. Cl. CPC G06F 3/0486; G06F 3/04845; G06F 3/04883; G06F 3/0482; G06F 9/543; G06F 2203/04803; G06F 2203/04808; G06F 3/03545

(57) ABSTRACT

Introduced here are techniques for implementing a clip-board menu on a device. The clipboard menu can be superimposed on a display of the device while a user is operating the device. The clipboard menu can include options to share, edit, and save content. The user can actuate the clipboard menu by selecting content being displayed on the device. The user can then drag the selected content to one of the options within the clipboard menu. The share option allows the user to share the content with other contacts or applications. The edit option allows the user to edit and/or crop the content. For example, the user can change the appearance of the content or crop out certain portions of the content. The save option allows the users to save the content to short-term or long-term memory. The user can then access the content by summoning a clipboard interface.

### CROSS-REFERENCE TO RELATED APPLICATION

This application claims priority to U.S. Provisional Patent Application No. 63/081,760 filed on Sep. 22, 2020, entitled “CLIPBOARD IMPLEMENTATION FOR SOFTWARE APPLICATION,” which is hereby incorporated by reference in its entirety.

### TECHNICAL FIELD

This disclosure relates generally to a software clipboard implementation on a user device, and more particularly, to techniques for implementing various software functions and user interface designs for a software clipboard.

### BACKGROUND

Mobile devices have become a crucial part of the daily life. So much so that there has been an exponential increase in mobile device usage in recent decades. This increase in usage has, in turn, prompted a similar increase in the functionality of and content available on mobile devices. Perhaps one of the most crucial reason for the increased popularity of mobile devices is that they enable average people to integrate the functionalities of a mobile device into their daily lives with ease. Thus, people nowadays have adapted their lives around the functionality of their mobile device(s).

Indeed, with the advancement in computer and network technology, the computing power in and functionality provided by a modern day mobile phone are astonishing. It is a part of the norm now to use personal mobile devices to perform daily tasks such as reading a book, ordering groceries, communicating with friends and family, working, learning, and many other tasks. As such, it is desirable to have techniques that can integrate the capabilities of mobile devices with user interfaces in a user friendly, intuitive, and convenient way, so that an average person can more easily navigate and effectively utilize the various functions provided by their mobile devices.

### BRIEF DESCRIPTION OF THE DRAWINGS

The techniques introduced here may be better understood by referring to the following Detailed Description in conjunction with the accompanying drawings, in which like reference numerals indicate identical or functionally similar elements.

FIG. 1 illustrates an example of a display including a clipboard menu.

FIG. 2A illustrates an example of a display prior to activation of a clipboard menu.

FIG. 2B illustrates an example of a display including a long-press activated clipboard menu.

FIG. 3A illustrates an example of a user dragging content towards a clipboard menu.

FIG. 3B illustrates an example of the changes in the appearance of content when the content is being dragged closer to a clipboard menu.

FIG. 4 illustrates an example of a clipboard menu as applied to email content.

FIG. 5 illustrates an example of a modified clipboard menu.

FIG. 6A illustrates an example of content being dragged to a sharing icon within a clipboard menu.

FIG. 6B illustrates an example of a sharing menu.

FIG. 7A illustrates another example of content being dragged to a sharing icon within a clipboard menu.

FIG. 7B illustrates another example of a sharing menu.

FIG. 8A illustrates an example of content being shared from one application to another application.

FIG. 8B illustrates an example of content being transferred to another application.

FIG. 9A illustrates an example of content being dragged to the cropping icon within a clipboard menu.

FIG. 9B illustrates an example of a cropping mode.

FIG. 10A illustrates an example of a cropping action performed for by a user.

FIG. 10B illustrates an example cropped portion being dragged towards a clipboard menu.

FIG. 11A illustrates an example of content being dragged to the save icon within the clipboard menu.

FIG. 11B illustrates an example of an alert when content has been copied to the clipboard.

FIG. 12A illustrates an example of a submenu that is generated when content is dragged near a save icon within the clipboard menu.

FIG. 12B illustrates an example of an alert when content is saved to a location on the device.

FIG. 13A illustrates another example of a submenu that is generated when content is dragged near a clipboard icon within the clipboard menu.

FIG. 13B illustrates another example of an alert when content is saved to a location on the device.

FIG. 14 illustrates an example of scrolling menu that is activated when content is dragged near a save icon.

FIG. 15A illustrates an example of a dock activated by a sliding gesture.

FIG. 15B illustrates an example of content being retrieved from the dock.

FIG. 16A illustrates an example of moving a dock with a sliding gesture.

FIG. 16B illustrates an example of the relocated dock.

FIG. 17A illustrates an example of removing text from a dock to an application.

FIG. 17B illustrates an example of text being dragged from the dock to the application.

FIG. 18 illustrates an example of an annotation functionality.

FIG. 19A illustrates an example of actuation of a prompt within a dock.

FIG. 19B illustrates an example of a clipboard application interface.

FIG. 20 illustrates a flowchart showing an example method for implementing the clipboard menu.

FIG. 21 illustrates a high-level block diagram showing an example of a mobile system in which at least some operations related to the techniques introduced here can be implemented.

### DETAILED DESCRIPTION

References in this description to “an embodiment,” “some cases,” or the like, mean that the particular feature, function, structure, or characteristic being described is included in at least one embodiment of the present disclosure. Occurrences of such phrases in this specification do not necessarily all refer to the same embodiment. On the other hand, the embodiments referred to also are not necessarily mutually exclusive.

The increased dependency on mobile devices has prompted those in the industry to improve the functionality of mobile device. Generally, the goal of improving the functionality of a mobile device is to help incorporate the mobile device into routine tasks, or at the least, to improve the routine task. For instance, banks now have applications that allow online check deposit, transfers, and other activities that traditionally required a visit to the bank. In another example, newspapers and magazines were traditionally hard copies. Nowadays, they are application-based and simulate the sections of the hardcopy equivalent.

On the other hand, the increased dependence on mobile devices has also highlighted the deficiencies of mobile devices. For example, the lack of interoperability between the applications on a mobile device, the primitive nature of content sharing capabilities, and the lack of options to customize content sourced from an application. For instance, a mobile device can have multiple applications on board (e.g., browser, messenger, camera, and photo library). However, a user of the mobile device can rarely move content from one source to another without difficulty due to lack of interoperability. For example, a user can be using the browser application to view pictures of a beach resort. If the user wanted to take a particular picture and append it to a text message, the user has to download the image to the mobile device, take a screen shot, or copy the uniform resource location (URL) of the image. Subsequently, the user has to open the messenger application, and progress through the menu in the messenger application to append the image to a text message. In other words, the user has to operate each application separately because of the lack of interoperability between the interfaces of each application.

Another issue, which in some cases is similar to the interoperability issue, is the primitive nature of content sharing capabilities. Currently, if a user wanted to share content to another person via text message, email, or other content sharing methods, the user has limited options. In particular, the options limit which content can be shared. For example, if a user is browsing a website and wants to share a particular image on the website with a friend, the user is limited to sharing the URL. In another example, if a user is scrolling through a digital furniture catalog and wants to share an image of a chair, the user is again limited to sharing the URL, or, in some cases, a screenshot.

Yet another issue is the inability to customize content sourced from an application. Currently, if a user wants to share or save content from an application, the user must save the entire selection of content to the device and then use another application to customize the content. For example, if a user liked a stool display within a living room displayed in digital furniture catalog, the user must first save the image of the living room. Then, the user can open another application (e.g., photo editor) to edit the image such that only the stool is shown before the user can utilize the stool image for other applications.

Introduced here, therefore, is a clipboard menu with various integrated options and functions (e.g., to share, save, and/or edit content). The clipboard menu can be populated on top of the interface of an application when prompted by actions such as a long press on content within the application. For example, the clipboard menu can be displayed in a radial fashion at a corner of the screen of a user device or as a vertical menu near a vertical edge of the user device. Once the clipboard menu appears, the user can drag content to any of the, at least, three icons to perform a task.

A first icon can be a share icon. The share icon can be actuated when content is dragged to and dropped by the user near the share icon. Once actuated, various submenus can be populated to help share the content. In general, submenus provide options of destinations for the content. The different submenus can group destinations based on commonalities. For example, one submenu can include a list of applications onboard the user device. Another submenu can include a list of contacts. In some embodiments, the share icon can prompt a series of submenus. For example, a first submenu can include a list of frequently contacted contacts. Once the user selects one contact, a second submenu can include a list of applications through which to share content to the content (e.g., WhatsApp or WeChat).

A second icon can be the save icon. Similar to the share icon, the save icon can be actuated when content is dragged to and dropped near by the user near the save icon. Once the content is dropped near the save icon, the content can be saved in the short term memory or long term memory of the user device such the random-access memory (RAM). In some embodiments, submenus can be populated which provides options for a saving destination. For example, the user may want to save content with a specific folder or other location on the device.

A third icon can be the edit icon. Similar to the share and save icons, the edit icon is actuated when content is dragged to and dropped near the crop icon. Once actuated, an editing interface can be populated which allows the user to edit the content. In some embodiments, the edit interface includes options to edit and/or crop the content. For example, the edit interface can include options to resize the content, change colors, and/or add content (e.g., text). Once the user has edited the content, the user can use the share and/or save functionality discussed above.

In the following description, the example of a mobile device is used, for illustrative purposes only, to explain various aspects of the techniques. Note, however, that the techniques introduced here are not limited in applicability to mobile devices or to any other particular kind of devices. For example, other electronic devices or systems (e.g., a laptop or a tablet) may adapt the techniques in a similar manner.

Further, in the following description, content is described as being any content within a user device. Note that content can include, for example, text, audio, images, animations, and/or video. Moreover, the content can also include metadata or other forms of data that enable reproduction of the content at another location.

### Clipboard Menu

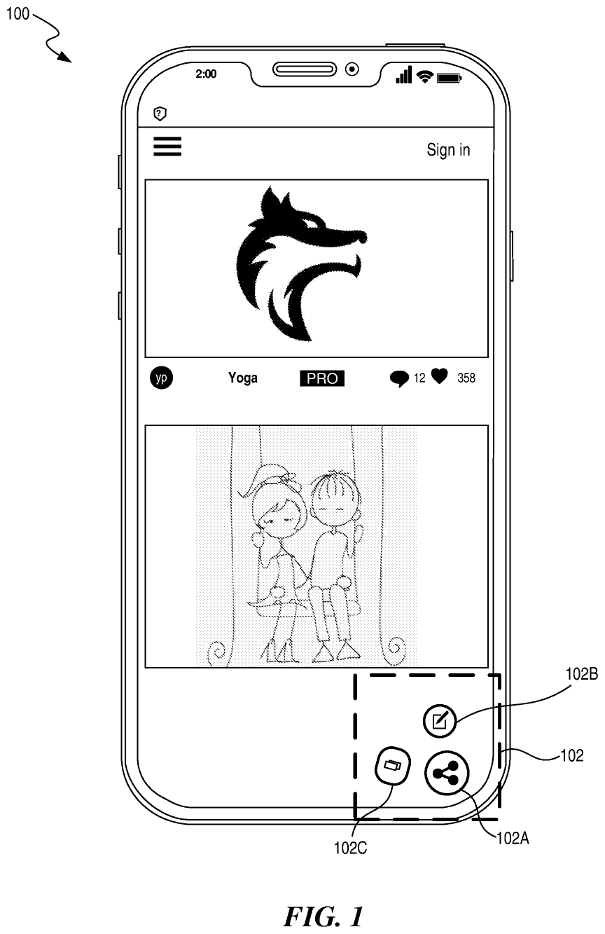

FIG. 1 illustrates an example of a display 100 including a clipboard menu 102. Clipboard menu 102 includes share icon 102A, edit icon 102B, and save icon 102C. The clipboard menu 102 can be a hidden menu that can be populated on the display 100 based on input from a user. The input can be a gesture, for example, a long press, a one-finger slide, a multi-finger slide, or other common gestures. In another example, the input can be a keyboard stroke, a mouse click, or mouse movement. For instance, the user can be viewing content on display 100. Initially, the clipboard menu 102 may not displayed or hidden from view. The user can then long-press on content within display 100 for a predetermined amount of time. Based on the long-press, the clipboard menu 102 can be populated at the bottom right corner of display 100.

In some embodiments, clipboard menu 102 can be superimposed on the display 100. For the purposes of this description superimposing means that graphical content is displayed over the background content such that both are remain evident and both maintain functionality. For example, a user device can be a displaying a browser and the user may be scrolling through the content within the browser. At the same time, the user device can also be displaying clipboard menu 102 at the bottom right corner (e.g., as depicted in FIG. 1). In another example, the user can be on the home screen of the user screen, prior to opening an application, and the clipboard menu 102 can be displayed at the bottom right corner of the display 100.

In some embodiments, clipboard menu 102 can be modifiable. Modifications can include, for example, changing the location of the clipboard menu 102, changing the arrangement of the icons within clipboard menu 102, changing the layout of clipboard menu 102, moving individual icons, or adding/removing functionality. For instance, a user device can display clipboard menu 102 at the bottom right hand of the display 100. However, a user may find that the clipboard menu 102 is a distraction from the background content. Thus, the user can select (e.g., long press) and drag clipboard menu 102 to another location on display 100. In some cases, depending on where the user drags the clipboard menu 102, the layout may automatically change. For example, if the user drags the clipboard menu 102 to a left or right edge of the screen, the clipboard menu 102 may automatically become a hidden menu or a vertical menu.

In another example, a user can add and/or remove functionality to clipboard menu 102. For instance, the user can add functionality by dragging and dropping an application near the clipboard menu 102. The user can remove functionality by dragging an icon (e.g., 102A) away from clipboard menu 102. Further, the user can change the default functionality of an icon. For example, the user can drag and drop the default messaging application of the user device near the share icon 102A. Once dropped, when the share icon 102A is actuated, the messaging application can be used by default.

The share icon 102A enables sharing of content using various methods. A user can actuate the share icon 102A by selecting, dragging, and dropping content near the location of the share icon 102A. Once actuated, the user device can open a sharing interface (e.g., menu) that prompts the user to select from various options to share the content. The sharing interface can be a series of menus, each with more filtered options. For example, the share interface can be opened when the user drags an image near the location of share icon 102A. The initial share interface can include various methods for sharing content such as through Bluetooth, near field communications (NFC), Email, messaging (e.g., WhatsApp or WeChat), and/or social media platforms (e.g., Instagram). Once the user makes a selection, a second menu can be displayed which includes further options. For instance, if the user selected Email, the second menu can include a list of frequently used email addresses. In another case, if the user selected a messaging application, the second menu can include a list of frequently messages contacts.

The edit icon 102B enables cropping and editing of content. Similar to the share icon 102A, the edit icon 102B can be actuated by selecting, dragging, and dropping content near the location of the edit icon 102B. Once actuated, an editing interface can be opened that provides the user with various options to crop and edit the content. The editing interface can include options to crop the content, edit the appearance (e.g., coloring), and/or add text to the content. For example, a user can drop an image of a furnished living room near the edit icon 102B. The editing interface can populate with the image and the cropping/editing options. Within the editing interface, the user can crop portions of the image. In this case, the user can crop a sofa or chair out of the image of the furnished living room. Once a portion is cropped, the editing interface can display only the cropped portion for further edits. In another example, the user can change the appearance of the image of the furnished room by changing the brightness, the color scheme, contrast, or other such aesthetic features.

The save icon 102C enables the user to save content into long term and/or short term memory. Similar to the other icons, the save icon 102C can be actuated when content is selected, dragged, and dropped near the save icon 102C. Once actuated, the save icon 102C can save the content to a default location or open a menu with location options. In either case, the location can be on the user device or elsewhere (e.g., cloud storage). For example, a user can drag a video clip near save icon 102C. The user may have previously selected a folder within the memory of the user device as the default location; thus, the video clip can be automatically stored with memory locations associated with the folder. Alternatively, a menu of locations can be populated, and the user can select a location.

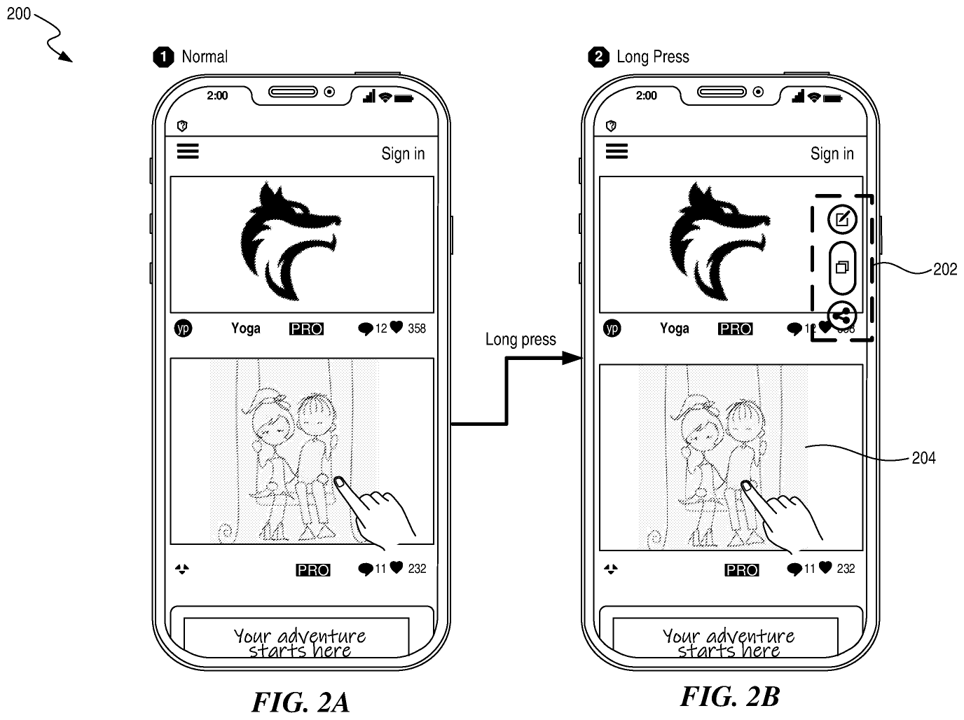

FIG. 2A illustrates an example of a display 200 prior to activation of a clipboard menu. In FIG. 2A, the user is scrolling through content on their device. As mentioned before, the user can be using the device for normal activity such as scrolling through content on an application, operating the home screen, or other activity normally performed on a user device. The clipboard menu (e.g., clipboard menu 102) can be a hidden menu in this case. Once the user selects content, the clipboard menu can be populated on the display 200. FIG. 2B illustrates an example of a display including a long-press activated clipboard menu 202. In FIG. 2B, the user can select by long-press the image 204 to use within the long-press activated clipboard menu 202. In other words, the long-press on image 204 has triggered the user device to display long-press activated clipboard menu 202.

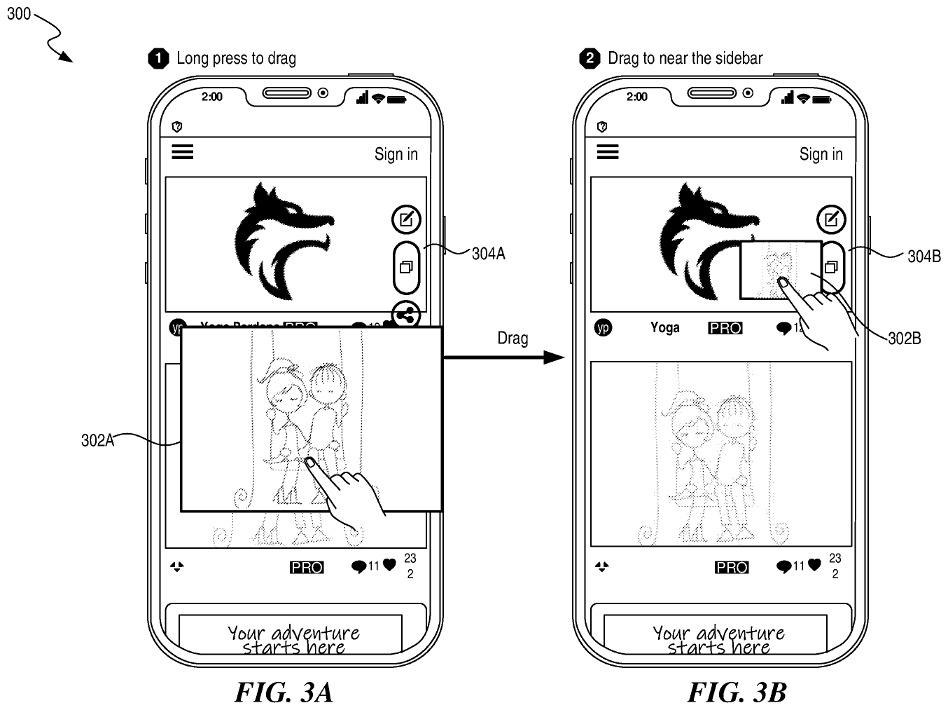

FIG. 3A illustrates an example of a user dragging content 302A towards a clipboard menu 304A. As depicted, the content 302A is dragged by the user, which begins with a long press. However, other gestures and devices may also be used. For example, the user may use a mouse to click and drag content 302A. In some embodiments, content 302A can be automatically resized as the drag gestures nears the clipboard menu 304A. By doing so, it makes it easier for the user to accurately drop the content 302A near the desired icon.

FIG. 3B illustrates an example of the changes in the appearance of content 302B when the content 302B is being dragged closer to the clipboard menu 304B. The content 302B is resized such that the user is able to drop the content near one of the icons within clipboard menu 304B. The resizing can be based on, for example, the size of the icons within clipboard menu 304B and/or the size of the display 300. In some cases, the size of the clipboard menu 304B may vary based on the location of the screen. Thus, the resizing of content 302B may also vary.

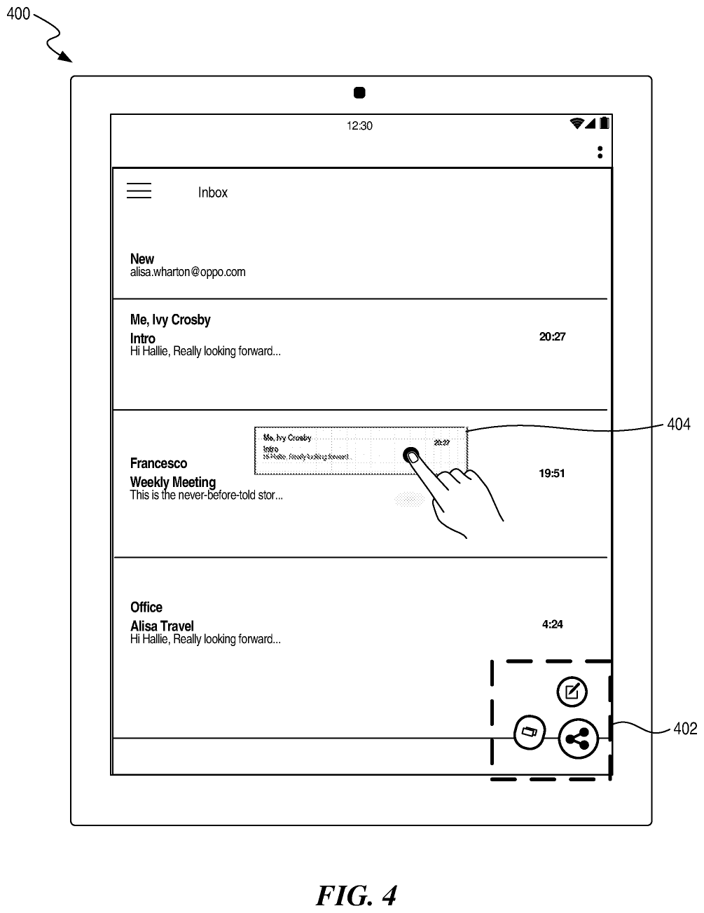

FIG. 4 illustrates an example 400 of a clipboard menu 402 as applied to email content 404. In general, the clipboard menu 402 can be utilized with many applications and content types. In FIG. 4, for example, the clipboard menu 402 is being used to share, save, and/or edit email content 404. The user can share the email content 404 with a contact, save the email content 404 at a desired memory location, or edit the email content 404. As discussed in further detail below, the user can save the email content 404 to long-term or short-term memory onboard the user device or to remote memory locations as well. By using the edit function, the user can, for example, change the appearance (e.g., color) or the content of the email content 404. For example, the user can crop out some of the text. Accordingly, the clipboard menu 402 is applicable to many applications and content types.

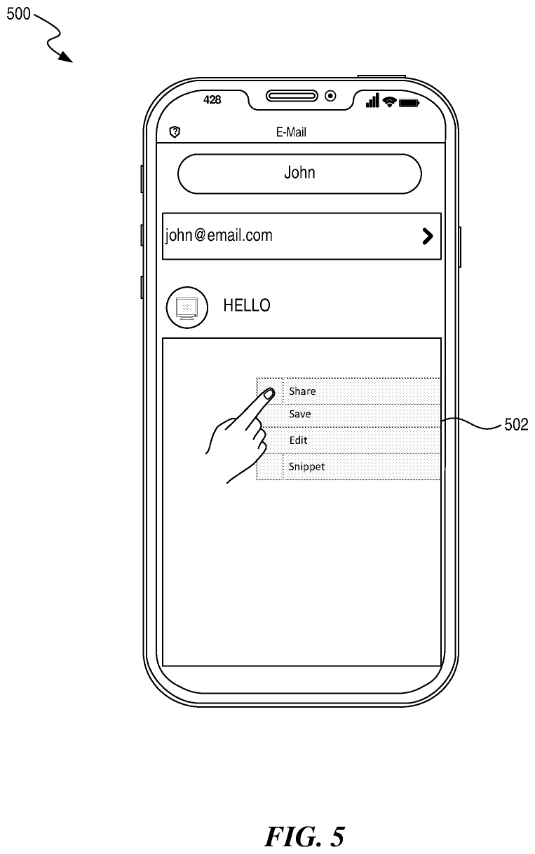

FIG. 5 illustrates an example 500 of a modified clipboard menu 502. The clipboard menu discussed here can change form depending on the context in which it is actuated. The context can be, for example, the underlying application, the type of content that is selected, how the clipboard menu is actuated, and/or user preference. Changes can include changes in appearance and/or changes in functionality. In FIG. 5, for example, the user has actuated the modified clipboard menu 502 within an email application. Due to this, the modified clipboard menu 502 has opened as a menu inline with where the user performed the actuation gesture (e.g., long press) and includes an additional option of snippet.

First, the modified clipboard menu 502 can be populated inline with the actuation gesture as a vertical menu. By doing so, it may easier for the user to access the functionality of the modified clipboard menu 502 while typing an email. For example, rather than dragging particular text to the location of a clipboard menu (e.g., clipboard menu 304A), the functionality of modified clipboard menu 502 is available near the text. Second, added functionality such as the snippet option, can help the user in the particular situation. Here, for example, the snippet functionality helps the user construct emails by providing predetermined text phrases. The text phrases can be contextually based and determined based on, for example, common phrases and user history. For example, the user may prefer to end an email using “Best Regards,”. Thus, the snippet functionality can propose “Best Regards,” when the user enters multiple spaces and begins a line with “B”.

In another example, while a user is watching a video, the added functionality can be to select a time range within the video. Once selected, the user may be able to use the other functionality within the modified clipboard menu 504. For instance, the user may be watching a five minute video. When the user actuates the clipboard menu, it can include a time range option in addition the save, share, and edit. The user can select the time range option, and subsequently select the first two minutes of the video. After which, the user can drag the first two minutes of the video to any of the other options within the clipboard menu, rather than the entire five minute video. Accordingly, a clipboard menu can include added functionality based on the context in which the clipboard menu is actuated.

### Sharing

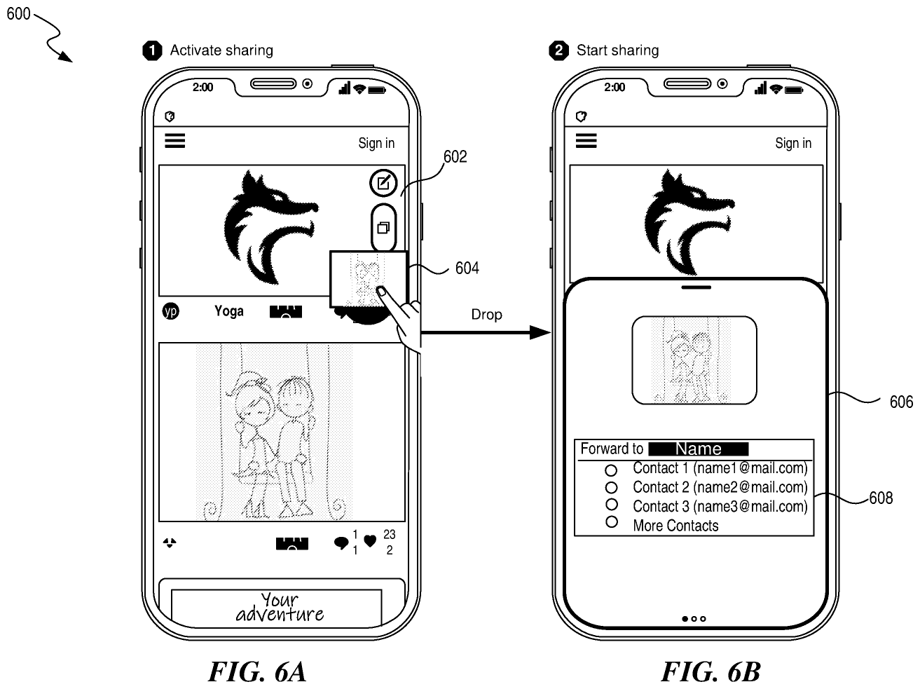

FIG. 6A illustrates an example of content 604 being dragged to a sharing icon within a clipboard menu 602 on display 600. Once the user drops the content 604 near the sharing icon, which is overlapped by content 604 in FIG. 6A, the user can be presented with options on how to share the content. As mentioned earlier, the user can be presented within a menu that included various methods for sharing. For example, a menu can include common applications used for sharing content and a subsequent menu can include frequently contacted contacts, or a single menu can include all the options necessary to share the content.

FIG. 6B illustrates an example of a sharing menu 606. Sharing menu 606 includes a contact list 608. In this case, the sharing menu 606 may have defaulted to an email application or the sharing menu 606 can be one of the menus in a series of menu. For instance, sharing menu 606 can be the second menu in a series of menus, where the first menu prompted the user to select an application for sharing. In the first menu, the user may have selected the email application. If the user had selected another application in the first menu, the second menu (e.g., sharing menu 606) may have a different user interface.

The contact list 608 can include frequently contacted emails, alphabetically organized email addresses, or another selection of email addresses. In FIG. 6B, the user is given the option to select an email address or the enter a name. If the user enters a name, the email addresses associated with the name may be populated within contact list 608. Alternatively, the user can simply select one of the email addresses already displayed. As another option, the user can opt to view more contacts, which can prompt contact list 608 to, for example, display other email addresses or open the contacts application within the user device.

Once the user selects a contact to share the content 604 to, the user device can share the content via the option selected by the user. The content 604 can include all the data necessary for the receiver of the content to reproduce the content 604 on their end. For instance, if the content 604 is an image, the receiver of content 604, upon receipt, can reproduce the image on their device. In another example, if the content 604 is a video, the receiver of the video can play the video on their device upon receipt.

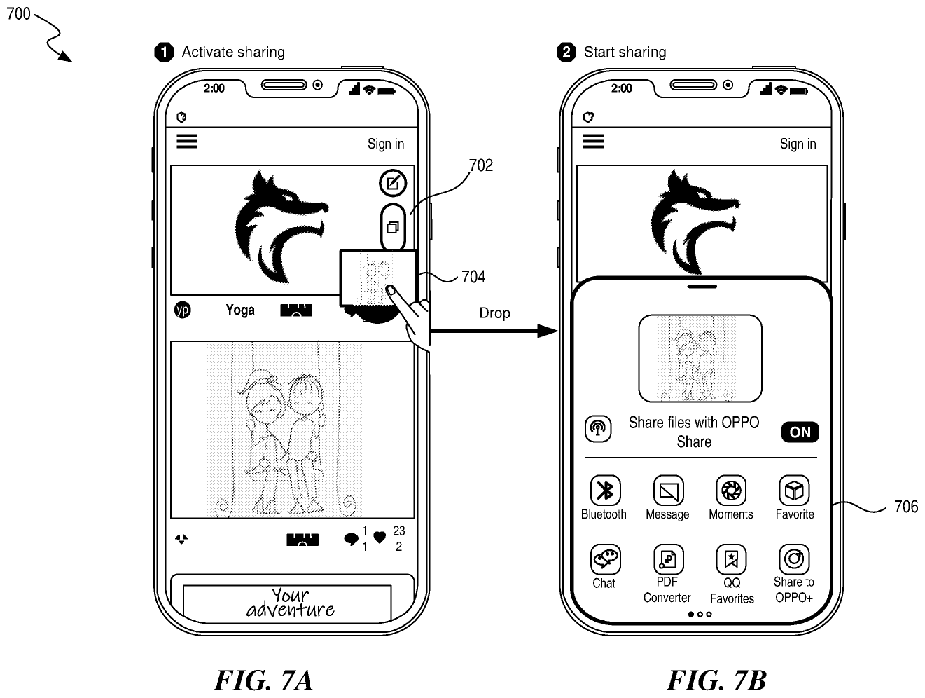

FIG. 7A illustrates another example of content 704 being dragged to a sharing icon within a clipboard menu 702 on display 700. FIG. 7A and its elements, 702 and 704 are similar to FIG. 6A and its elements, 602 and 604, respectively. Here, FIG. 7B illustrates another example of a sharing menu 706. Sharing menu 706 includes options of applications to which the content 704 can be shared. The content 704 can be shared to an application that enables connecting with others (e.g., Chat), as mentioned before. Additionally, content 704 can be shared to another application such that the content 704 can be viewed within the interface of that application. For example, content 704 can be shared to the “PDF Converter” application. Thus, the user device can open the “PDF Converter” application and integrate the content 704 into the interface of the “PDF Converter” application. In other words, and more generally, content 704 can be shared to any application, integrated into the interface of the shared-to application to use functionality of that application.

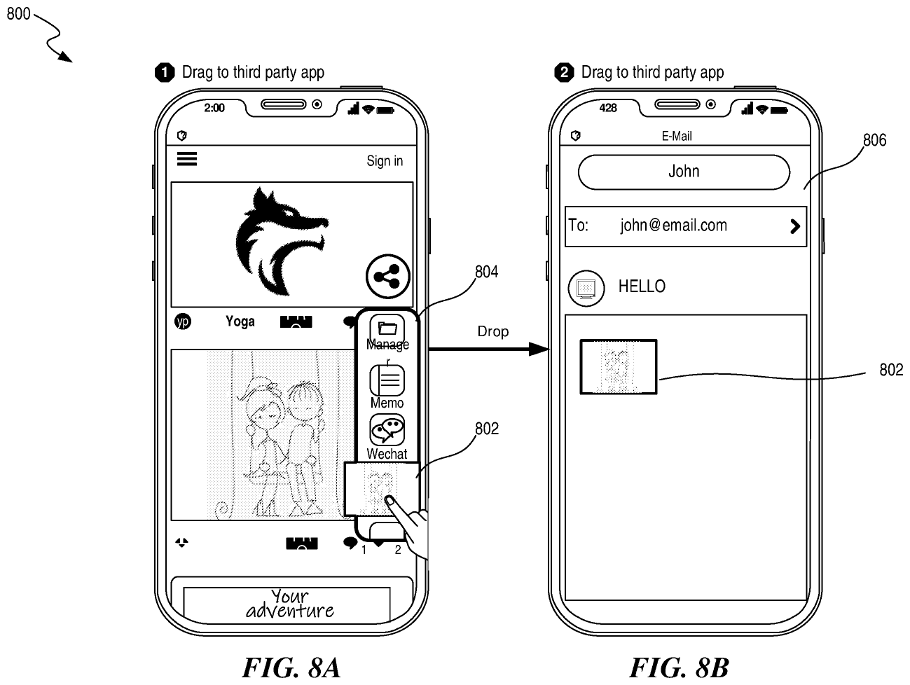

FIG. 8A illustrates an example 800 of content 802 being shared from one application to another application. FIG. 8A also includes menu 804, which is similar in functionality to sharing menu 606 from FIG. 6B and clipboard menu 706 from FIG. 7A. Here, the menu 804 is a vertical menu near the edge of the display. The user can drag content 802 to a location on the menu 804 by not terminating the dragging gesture. The user can drag the content 802 near the sharing icon, hold the content 802 near the icon until the menu 804 is populated, then continue to drag the content 802 to the desired option.

FIG. 8B illustrates an example of content 802 being transferred to another application. Once the user drops the content 802 at the desired option (e.g., application) on the menu 804, the selected application can be opened with the content 802 placed therein. In FIG. 8B, the user selected the email application 806. Thus, the content 802 is transferred to the email application 806 and placed within the interface of the application. In some embodiments, the content 802 can be transferred as an attachment to an email, rather than pasted in the text box. In some embodiments, the location within the selected application the content 802 is transferred to can vary based on the type of content. For example, if the content 802 was an email address, rather than an image, the content 802 can be transferred to the “to” text box, rather than the body of the email.

In some embodiments, there may be an intermediary step between the selection of the application in FIG. 8A and the opening of the selected application shown in FIG. 8B. The intermediary step can include options based on the selected application. In this case, the user selected the email application. Thus, the intermediary step can include options such as where to paste the content 802, who the email should be directed to, or how the content 802 should be transferred to the email application.

### Editing

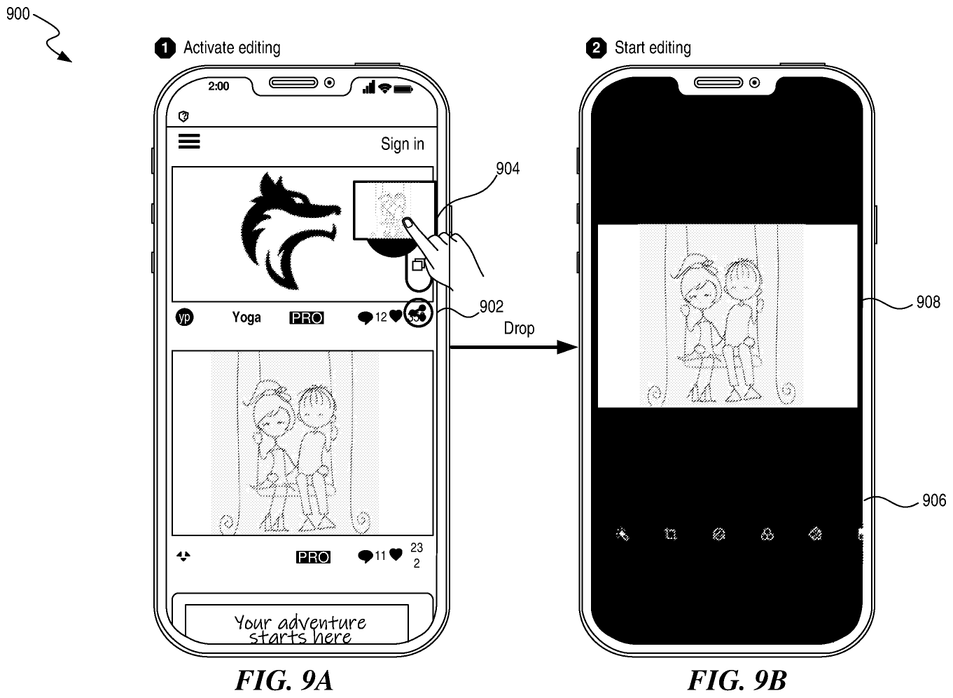

FIG. 9A illustrates an example of content 904 being dragged to the editing icon within a clipboard menu 902 displayed on display 900. As depicted in FIG. 9A, the editing icon is not displayed because content 904 is being dragged over the editing icon. Once the user drags and drops content 904 near the location of the editing icon within clipboard menu 902, the editing mode 906 can be displayed. In some embodiments, the user may not need to drag content 904 near the editing icon. Rather, the user may be able to select the editing icon to initiate an editing tool. The editing tool can allow the user to cut out (e.g., draw a circle around) the content 904 from the display 900. After doing so, the editing mode 906 may automatically be displayed with the cropped content so as to allow the user to perform further edits.

FIG. 9B illustrates an example of an editing mode 906. Editing mode 906 can include the content 908 and several editing options for the user to apply. In some embodiments, the editing mode 906 can include prompts to edit the size, color scheme, and/or to add text or features onto the content 908. For instance, a user can edit content 908 to change the brightness or the black and white contrast. In another example, the user can add text by using a finger-drag gesture, a stylus, or typing on a keyboard of the user device.

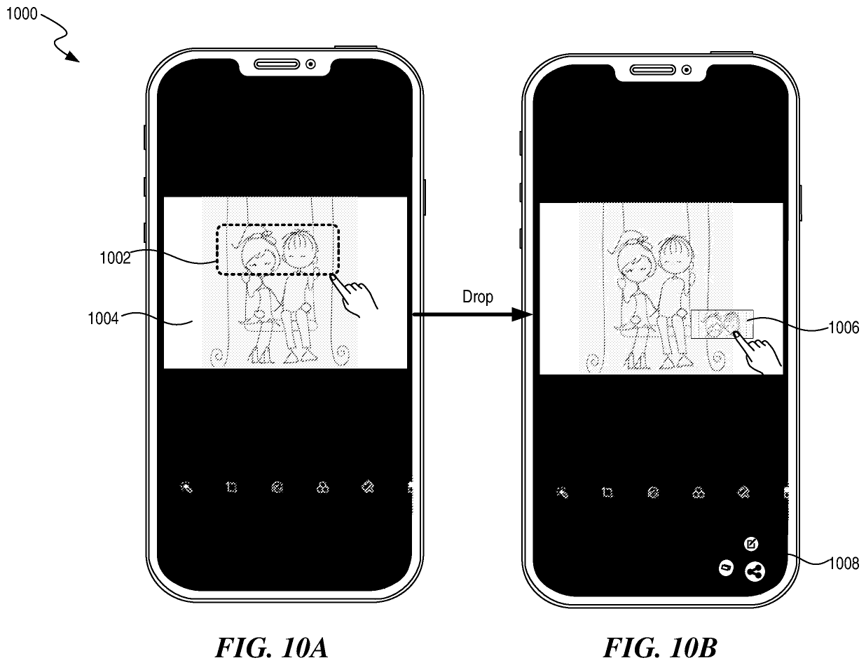

FIG. 10A illustrates an example of a cut out 1002 drawing by a user to crop content within editing mode 1000. Cut out 1002 is a portion of content 1004. The user can draw a figure (e.g., circle or square) around a portion of content 1004. The portion can be, for example, the portion that the user is interested in. Here, the user has drawn around the faces of the characters in content 1004 to create cut out 1002. In some embodiments, the editing mode 1000 can detect that the user is finished cropping when the user, for example, picks up their finger or the start and end point of the drawing meet.

Once the user has completed drawing a figure around the cut out 1002, the user can perform other tasks with the cut out 1002. FIG. 10B illustrates an example of cropped portion 1006 being dragged towards a clipboard menu 1008. In some embodiments, the user can re-actuate the clipboard menu 1008 for use with the cropped portion 1008. In another example, the cropped mode 1000 can discard the remaining portions of the content 1004 and allow the user to edit (e.g., change color scheme) the cropped portion 1006.

### Saving

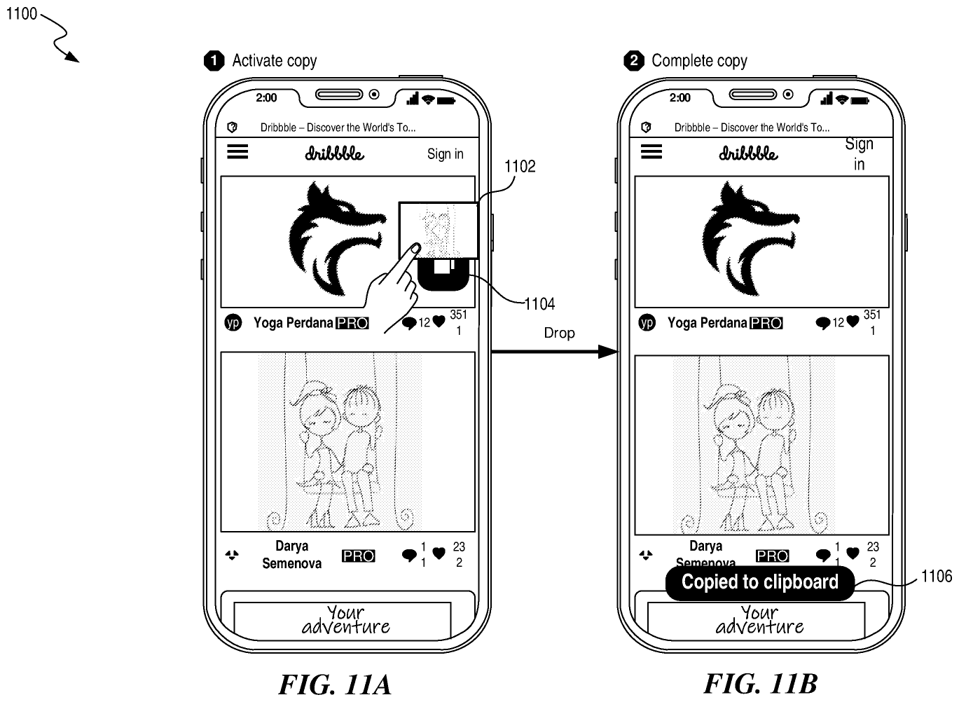

FIG. 11A illustrates an example of content 1102 being dragged to the save icon 1104 on display 1100. As mentioned before, the drag gesture can also be other common gestures such as a mouse click and drag. Once the content 1102 is dropped near save icon 1104, the content can be saved to short-term or long-term memory. In some cases, the content 1102 can be saved to a default memory location. FIG. 11B illustrates an example of an alert 1106 when content has been dropped near the save icon 1104. The alert 1106 can include a message informing the user of the memory location that the content was saved to. In FIG. 11B, the content was saved the clipboard. The clipboard is a buffer that some operating systems provide for short-term storage and transfer within and between application programs. The clipboard is usually temporary and unnamed, and its contents reside in the computer's RAM.

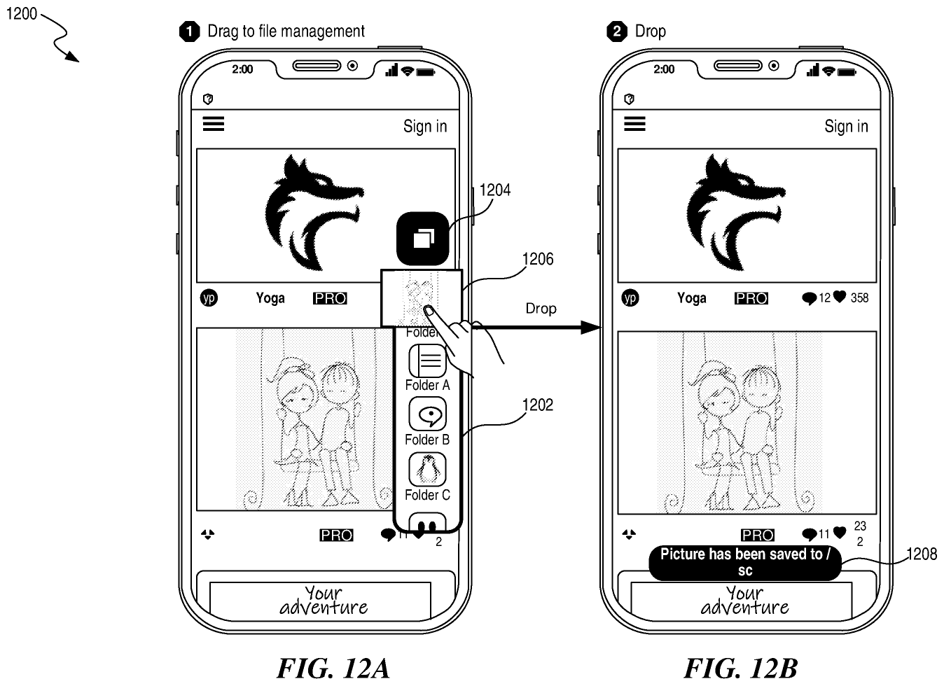

FIG. 12A illustrates an example of a submenu 1202 that is generated when content 1204 is dragged near a save icon 1206 on display 1200. Unlike the example of the default location described in conjunction with FIGS. 11A and 11B, FIG. 12A shows a submenu 1202 that provides the user with options of locations where the content 1206 can be stored. The submenu 1206 can include, for example, a list of frequently saved-to locations, or frequently visited locations.

The submenu 1206 can be populated on display 1200 once the user drags content 1206 near save icon 1204. The user, without terminating the drag gesture, can drag the content to the desired selection within the submenu 1202. Alternatively, the user can drop the content 1206 near save icon 1204. Once the content 1206 is dropped, the submenu 1202 can be populated. The use can then make the selection and the content can be saved to the selected location. In this case, the content 1206 can be stored in the short-term memory of the user device, after the content 1206 is dropped and prior to the user making a selection from submenu 1202.

Once the content 1206 is dropped at a location on the submenu 1202, an alert 1208 can be displayed. FIG. 12B illustrates an example of the alert 1208 when content is saved to selected location. Similar to alert 806 in FIG. 8B, alert 1208 can inform the user that the content 1206 has been saved to the selected location. The alert 1208 can be superimposed at the bottom of the display 1200. In some embodiments, the alert 1208 can be a time based alert. In other words, the alert 1208 can appear on the display 1200 for a predetermined amount of time and automatically disappear. In some embodiments, the alert 1208 may gradually disappear by becoming gradually transparent over a predetermined amount of time.

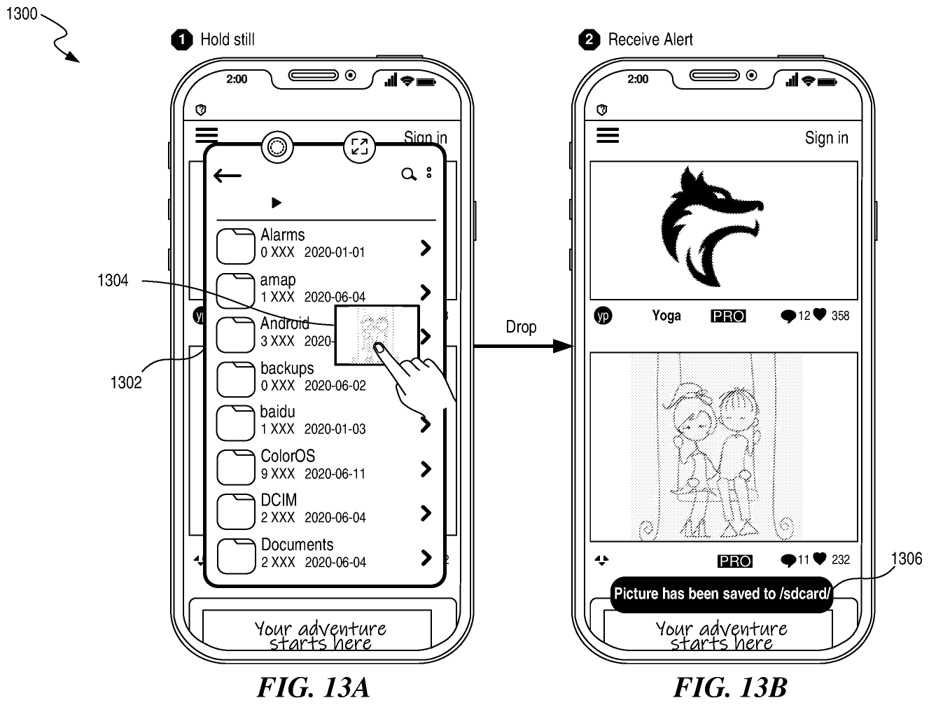

FIG. 13A illustrates another example 1300 of a submenu 1302 that is generated when content 1304 is dragged near a save icon within the clipboard menu. Submenu 1302 is similar in functionality to submenu 1202. Generally, submenu 1302 provides a list of options where the content 1302 can be saved to. Unlike submenu 1202, submenu 1302 is larger and provides more details about the options. Once the user selects a location, the user can receive an alert, as mentioned before. FIG. 13B illustrates an example of an alert 1306 when content is saved to a location on the device. Similar to alert 1208, alert 1306 provides confirmation that the content 1304 was saved to the selected location.

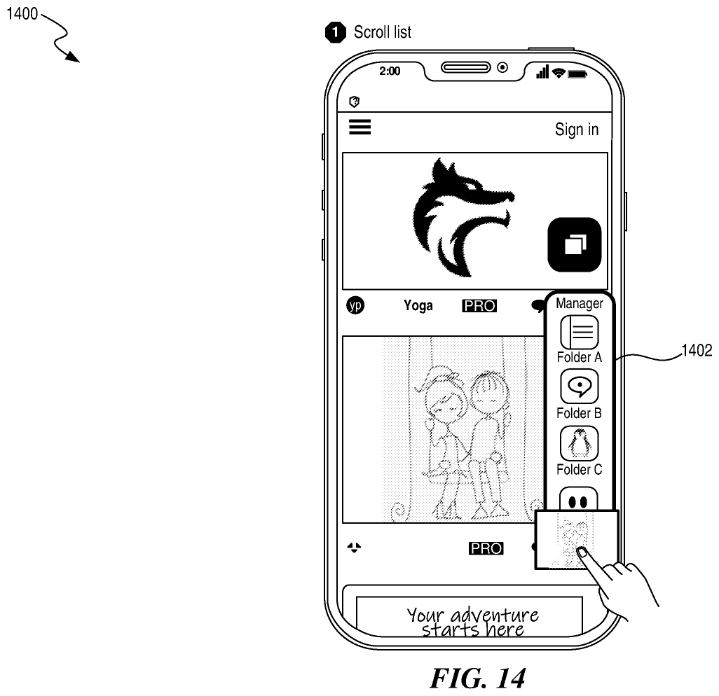

FIG. 14 illustrates an example of scrolling menu 1402 that is activated when content is dragged on display 1400 near a save icon. The scrolling menu 1402, similar to submenu 1202 in FIG. 12A, includes a list of locations where content can be saved. As the user drags content towards the bottom of the scrolling menu 1402, the scrolling menu scrolls to display more options. Similarly, the user can drag content to the top of scrolling menu 1402, to scroll in the opposite direction. Although this feature has been described in conjunction with the save icon, it should be noted, however, that a scrolling menu can be populated when content is dragged to any of the icon within a clipboard menu.

### Dock

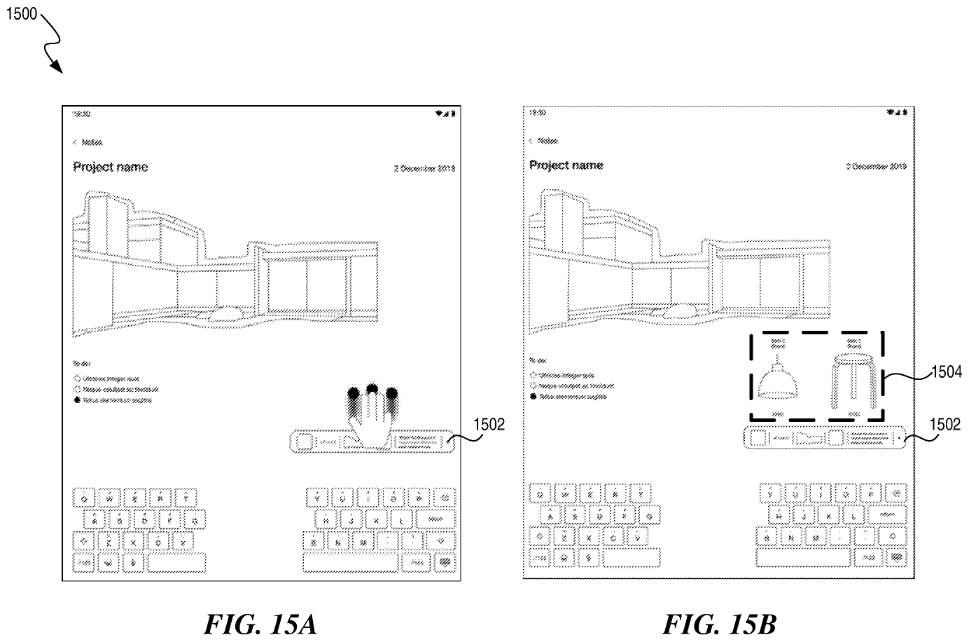

FIG. 15A illustrates an example of a dock 1502 activated by a sliding gesture. The dock 1502 can include content that was most recently saved when content was dragged to the save icon within the clipboard menu. For example, the content may have been saved, by default, to the clipboard of the user device, as described in conjunction with FIG. 8B. In another example, the dock 1502 may display content from a user-selected memory location or location on the user device.

The dock 1502 can be actuated with a sliding gesture, such as the three finger sliding gesture depicture in FIG. 15A. Other common gestures can alternatively be used to summon the dock 1502. For example, the user can flick upward from the bottom of the screen to populate dock 1502. In another example, dock 1502 can be partially hidden such that only a prompt is displayed on display 1500. When the user selects the prompt, the dock 1502 can appear on display 1500. In some embodiments, the dock 1502 can be populated inline with the gesture. In other words, the dock 1502 can be populated in the same location on the display 1500 as the gesture.

In some embodiments, the dock 1500 can be populated when the user is using an interface prompted by actuation of one of the functionalities of the clipboard discussed herein. For example, once a user drags and drops content near an icon within the clipboard menu (e.g., share icon 102A, edit icon 102B, or save icon 102C), and the corresponding interface is populated, the dock 1502 can be summoned. In FIG. 15A, for example, the user is using a notes application. The user may have opened the notes application because they dragged content to the share icon and then selected the notes application from a submenu. Thus, the user is now viewing the content with the notes application and can call the dock 1502.

In some embodiments, the dock 1502 can be called at any time, irrespective of when the user previously dragged content to the clipboard menu. For example, the user may be using the notes application to draft a to-do list. While doing so, the user may remember content that saved to the clipboard regarding a matter on the to-do list. To retrieve the content, rather than try to find the original source, the user may perform a gesture to populate the dock 1502 to view the content.

FIG. 15B illustrates an example of content 1504 being retrieved from the dock 1502. In order to retrieve content from the dock 1502, the user can select the content within the dock 1502 and drag it to another location on display 1500. For example, in FIG. 15B, the user can drag the content from dock 1502 to the notes application. Once dragged into the notes application, content 1504 can be automatically resized such that it is more visible on display 1500. In some embodiments, when content 1504 is retrieved from the dock 1502, the content is copied such that the dock 1502 continues to store content 1504 and the notes application has a copy of content 1504. Thus, if the user called dock 1502 at a later time, content 1504 would be visible within dock 1502 again. Alternatively, once content 1504 is retrieved from the dock 1502, the content 1504 can be removed from the dock 1502 (e.g., clipboard).

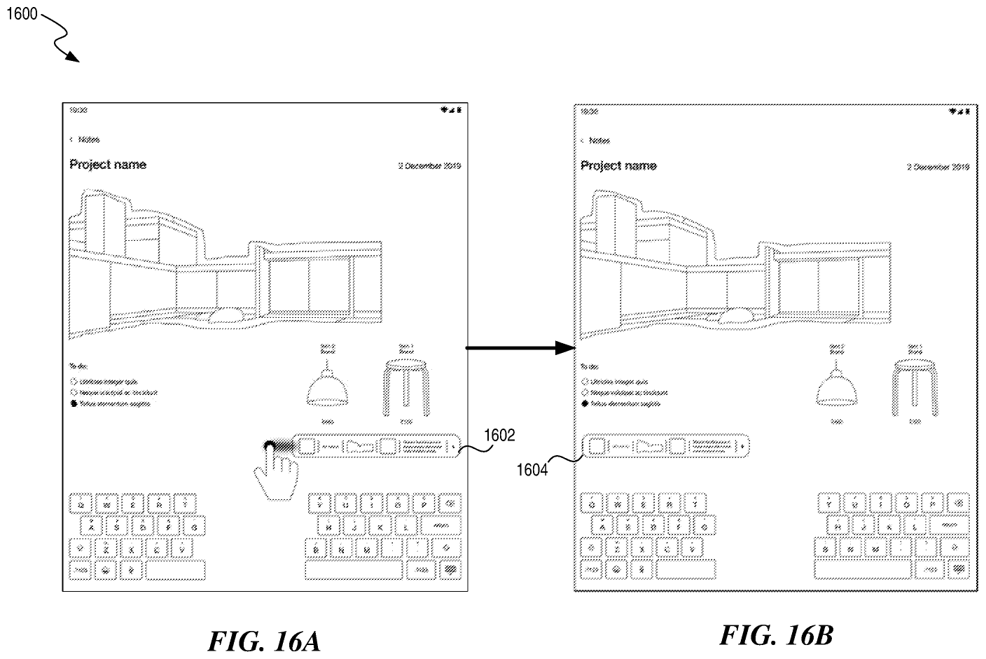

FIG. 16A illustrates an example 1600 of moving a dock 1602 with a sliding gesture. In some embodiments, the dock 1602 can be relocated to another location of the display. As mentioned above, in some embodiments, the dock 1602 can be populated inline with the gesture that was used to summon the dock 1602. Afterwards, the dock 1602 can be moved by performing common gestures such as the sliding gesture. The sliding gesture can start at a location on the dock 1602 and slide in the direction in which the dock 1602 should be moved.

In some embodiments, the dock 1602 can move along with the gesture. For example, the dock 1602 can be moved along the gesture (e.g., finger) and relocate to the location where the gesture ends. In some embodiments, the dock 1602 can always have one end near an edge of the screen. Thus, in FIG. 16A, when the user gestures to the left, the dock 1602 will relocate such that the left side of the dock 1602 is near the left edge of the display. Similarly, if the user gestures towards the top of the display, the dock 1602 can relocate such that the top edge of the dock 1602 is near the top edge of the screen.

FIG. 16B illustrates an example of the relocated dock 1604. In FIG. 16A the user gestured to the left. Thus, relocated dock 1604 has moved to the left relative to its original position. In some embodiments, the layout of the relocated dock 1604 may change in relation to dock 1602. For example, if the user moved the relocated dock 1604 to the edge of the screen, the relocated dock 1604 can be vertical, rather than horizontal. In some embodiments, the user can remove relocated dock 1604 from the screen with a gesture. For example, if the user gestures to the bottom of the screen, the relocated dock 1604 may disappear.

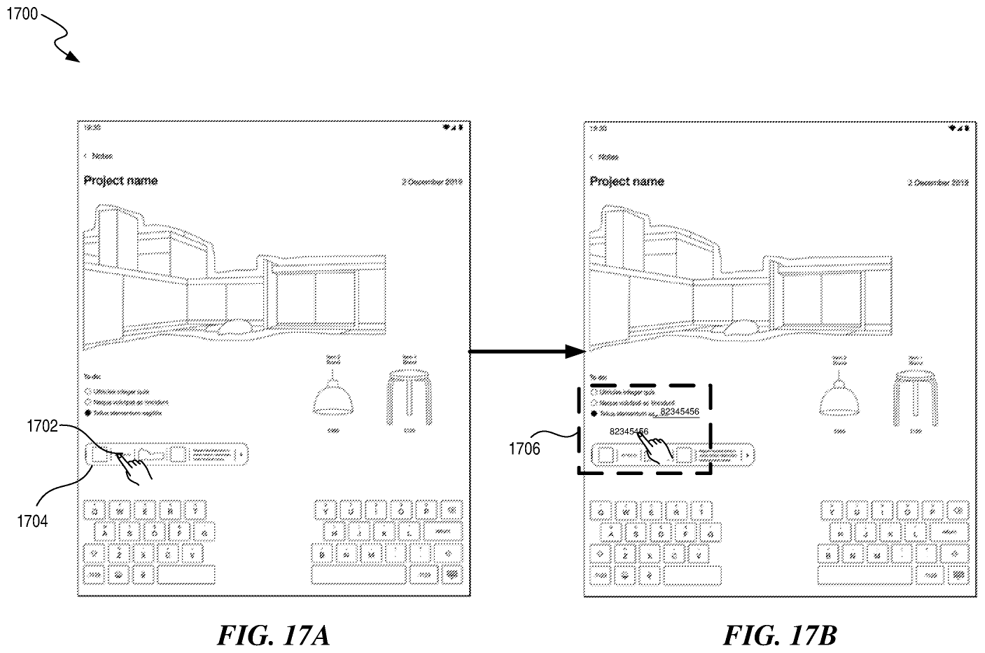

FIG. 17A illustrates an example of removing text 1702 from a dock 1706 to another application within display 1700. Similar to the content 1504 in FIG. 15B, text 1702 can be selected and dragged from the dock 1704 to another application (e.g., the notes application). FIG.

17B illustrates an example 1706 of text being dragged from the dock to the application. The user can drag and place the text at a desired location. In some embodiments, the user may be able to remove only a selected part of text 1702, rather than the entirety of text 1702. For example, the user may be able to select a portion of the text 1702 within dock 1704, and then drag only the selected portion to another location.

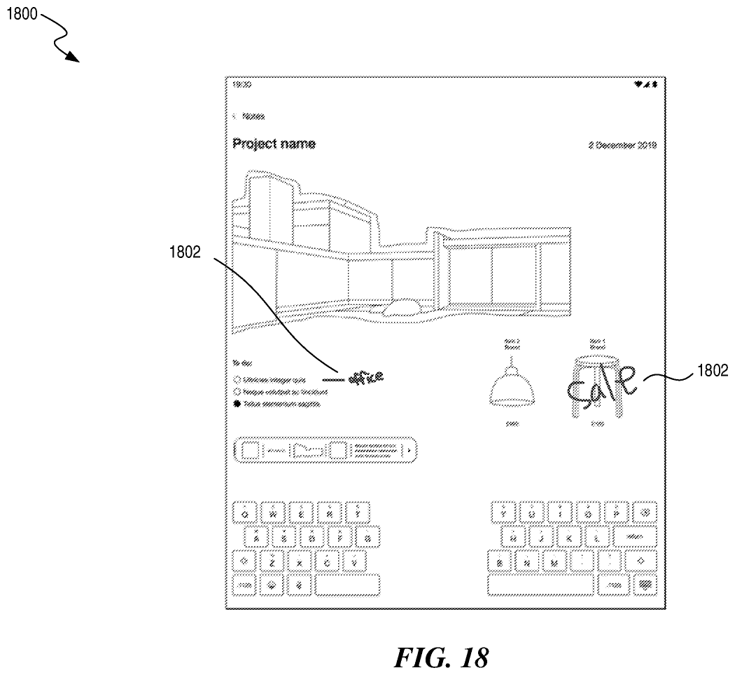

FIG. 18 illustrates an example 1800 of an annotation functionality. Although the annotation feature is described in conjunction with the dock, it should be noted, however, that annotation is possible without the dock as well. A user can annotate by using, for example, a stylus or finger, to draw or add annotations 1802 to an application. The annotations 1820 can be displayed over other content. In some embodiments, the annotations 1820 can be saved as content using the clipboard menu described herein.

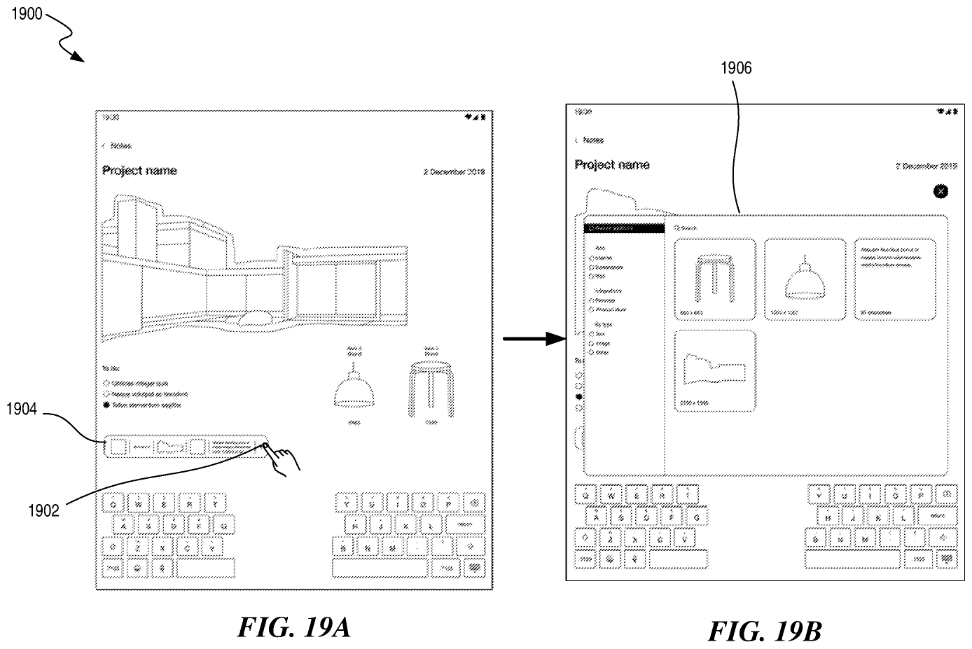

FIG. 19A illustrates an example 1900 of actuation of a prompt 1902 within a dock 1904. The prompt 1902 can be actuated by a common gesture such as a press or a click. Once actuated the clipboard application interface 1906 can be displayed. FIG. 19B illustrates an example of a clipboard application interface 1906. The clipboard application interface 1906 can include the content that was previously dragged to the icons within the clipboard menu discussed herein (share icon 102A, edit icon 102B, or save icon 102C). In some embodiments, the clipboard application interface 1906 can include only the content that was previously dragged to the save icon within the clipboard menu discussed herein.

The content within the clipboard menu interface 1906 can be organized based on, for example, the source of the content, the type of content, or when the content was dragged to an icon. For example, the user may have previously dragged a video from a browser to the save icon, an image from a text message to the share icon, and an audio recording from a browser to the save icon. Each content can be classified accordingly and displayed under multiple categories. For example, the video can be categorized under video and as being originated from the browser. Thus, the user can use the clipboard application interface 1906 to view all the content stored on the clipboard, while the dock 1904 displays only the most recent content stored on the clipboard.

In some embodiments, the categories can be separated into folders. The folders can then be shared, similar to other content. For example, a folder can be “Videos”, which includes all the videos that have been dragged to an icon within the clipboard menu. The user can then share the “Videos” folder as any other folder within the device. For instance, the user can right-click or long-press on the folder and select the sharing option. In another example, the user can activate the clipboard menu discussed herein and drag the folder to the share icon.

In some embodiments, the clipboard application interface 1906 can be integrated with and retrieve content from third-party sources. For example, the clipboard application interface 1906 can be integrated with a Resource Description Framework Site Summary (RSS) feed. The clipboard application interface 1906 can then display content from the RSS feeds such that the user can drag and drop content as previously described. In some embodiments, the clipboard application interface 1906 can be integrated with content partners (e.g., Pinterest). Thus, the clipboard application interface 1906 can display a graphical user interface (GUI) of a content partner.

For example, while viewing the clipboard application interface 1906, the user may select an option to view content from Pinterest. The clipboard application interface 1906 can then display a Pinterest GUI. The user can then view and retrieve content from the Pinterest GUI as previously described. Further, in some embodiments, the folders within clipboard application interface 1906 can be synced with multiple contacts. Thus, the contents of the folder can be viewed and edited by the multiple contacts. This can be done by storing the folder in a shareable memory location. For example, one of the content partners can be a shared drive, file sharing system, or other collaboration tools. The user can then share the location to other contacts and collaborate with them to update the content within the folder.

### Methodology

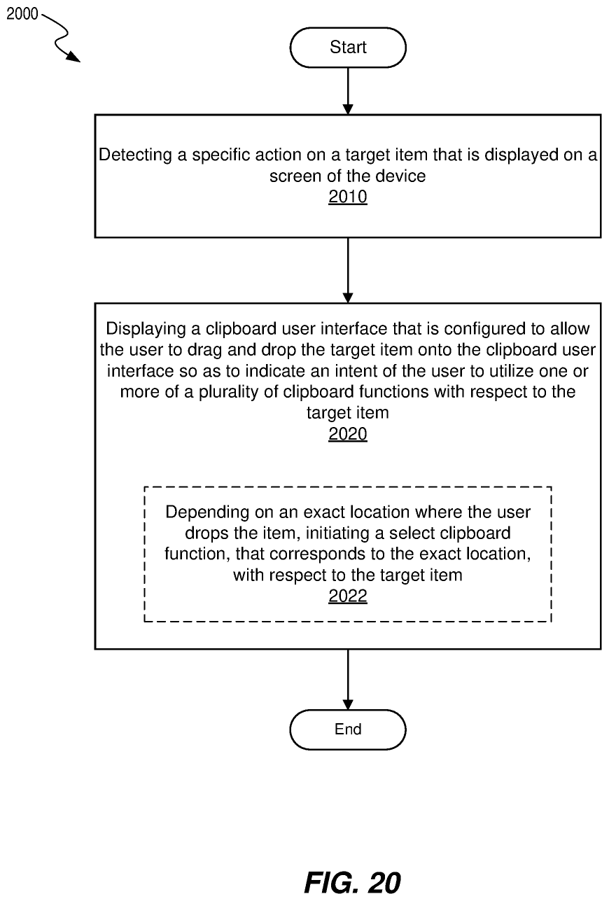

FIG. 20 illustrates a flowchart showing an example method 2000 for implementing the clipboard menu. The method 2000 can be implemented by various components of a device which can execute instructions based on user input to adapt a screen of the device to display content. For instance, a device can be any device which includes a processor and a memory having instructions thereon that are executable by the processor. Further, the device can be a computing device that includes telephony functionality and the screen of the computing device includes a touchscreen display. In another example, the method 2000 can be executed by a computer system, which executes instructions stored on a non-transitory computer-readable medium.

First, at block 2010, the method 2000 comprises detecting a specific action on a target item that is displayed on a screen of the device. The specific action can include a user interface gesture that stimulates a grab of the target item. For example, the grab can include a drag of the target item. In another example, the grab can include a long press on the target item, wherein the long press includes a press and a hold down that exceeds a predetermined amount of time. Further, the specific action can be performed on a variety of target items. For example, the target item can include one or more of an email, a calendar event, a piece of weather information, a three-dimensional item, an audio record, or a video recording.

Next, at block 2020, the method includes displaying a clipboard user interface that is configured to allow the user to drag and drop the target item onto the clipboard user interface so as to indicate an intent of the user to utilize one or more of a plurality of clipboard functions with respect to the target item. In some embodiments, as in block 2022, depending on an exact location where the user drops the item, initiating a select clipboard function, that correspond to the exact location, with respect to the target item.

The clipboard user interface can include a number of clipboard function areas that each correspond to one clipboard function. In some embodiments, the number of clipboard function areas can be arranged in a radial fashion, extending from a common center. Within the clipboard user interface, a main clipboard area can represent a storage space of the clipboard. The main clipboard area can occupy the common center. In some embodiments, the clipboard function area can be displayed on a clipboard user interface as an icon that represents the clipboard function area.

One of the clipboard functions can include a sharing function. The sharing function can include a method comprising detecting, based on an exact location where the user drops the target item, whether the intent of the user is to utilize the sharing function. In response to detecting the intent to utilize the sharing function, displaying a sharing user interface that includes contact information so as to allow the user to initiate sharing of the target item with one or more contacts displayed on the sharing user interface.

Another of the clipboard functions can include an inline editing function. The inline editing function can include a method comprising detecting, based on an exact location where the user drops the target item, whether the intent of the user is to utilize the inline editing function. In response to detecting the intent to utilize the inline editing function, displaying an inline editing interface that includes an editorial tool so as to allow the user to perform inline editing to the target item. In some embodiments, the editorial tool which is displayed in the inline editing interface can change based on a content type of the target item. For example, the target item can be an image and editorial tool can include a cropping tool. Further, the cropping tool can include a stylus that allows the user to remove a portion of the image before the image is added to the clipboard. In another example, the target item can be an audio and/or video recording and the editorial tool can include a tool to change the length of the recording.

In some embodiments, the method 2000 can include detecting a dock summon common by the user and in response to the dock summon command being detected, displaying a dock that includes items that are in the clipboard. The dock summon command can be a gesture and the dock can be displayed at a location where the gesture is performed by the user. For example, the dock summon command can be a user selectable gesture. The gesture can be based on three-fingers sliding toward the same direction.

In some embodiments, displaying the dock can further include detecting a location of a point device that is controlled by the user and in response to detecting that the location of the pointing device is over a given item displayed in the dock, displaying a menu of functions associates with the given item. In some embodiments, the items displayed in the dock can change based on the type of application on which the user initiated the dock summon command.

In some embodiments, the dock can be moved. Doing so includes detecting that the user drags the dock and relocating the dock to a location where the user drops the dock. Further, the dock includes a visual indicium that represents an annotation function that comprises detecting that the user selects the annotation function and displaying a stylus so as to allow the user to annotate one or more items in the clipboard.

The method 200 can further comprise automatically receiving, based on a user configuration and from a networked server, data representing content of interest of the user, and including the content on interest of the user in the clipboard. Further, the method 200- can include synchronizing, based on a user configuration, the clipboard with another clipboard that belongs to another user.

### Computer System And Device Architecture

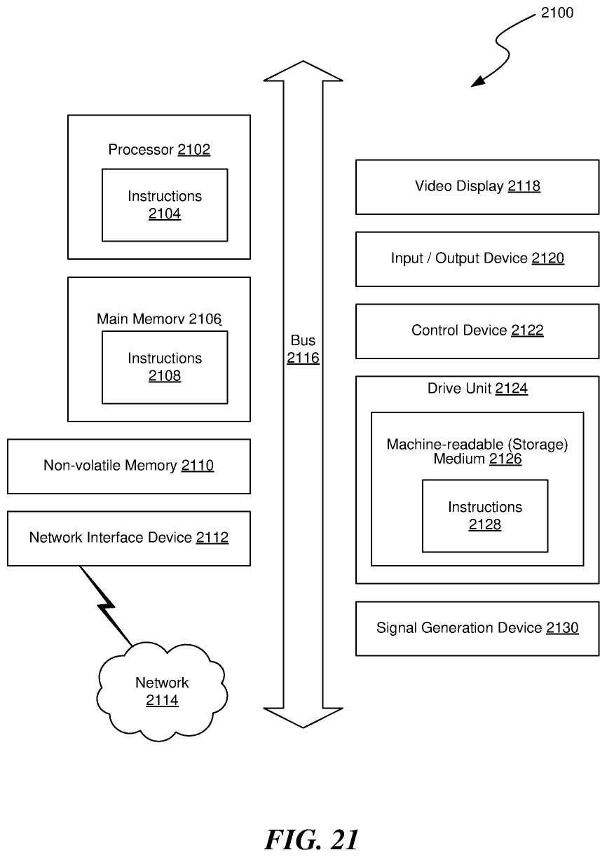

FIG. 21 is a block diagram illustrating an example of a computing system 2100 in which at least some operations described herein can be implemented. For example, some components of the computing system 2100 utilized to implement a computing device that includes component to implement a clipboard menu.

The computing system 2100 may include one or more central processing units (also referred to as “processors”) 2102, main memory 2106, non-volatile memory 2110, network adapter 2112 (e.g., network interface), video display 2118, input/output devices 2120, control device 2122 (e.g., keyboard and pointing devices), drive unit 2124 including a storage medium 2126, and signal generation device 2130 that are communicatively connected to a bus 2116. The bus 2116 is illustrated as an abstraction that represents one or more physical buses and/or point-to-point connections that are connected by appropriate bridges, adapters, or controllers. The bus 2116, therefore, can include a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus (also referred to as “Firewire”).

The computing system 2100 may share a similar computer processor architecture as that of a personal computer, tablet computer, mobile phone, game console, music player, wearable electronic device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the computing system 2100.

While the main memory 2106, non-volatile memory 2110, and storage medium 2126 (also called a “machine-readable medium”) are shown to be a single medium, the term “machine-readable medium” and “storage medium” should be taken to include a single medium or multiple media (e.g., a centralized/distributed database and/or associated caches and servers) that store one or more sets of instructions 2128. The term “machine-readable medium” and “storage medium” shall also be taken to include any medium that is capable of storing, encoding, or carrying a set of instructions for execution by the computing system 2100.

In general, the routines executed to implement the embodiments of the disclosure may be implemented as part of an operating system or a specific application, component, program, object, module, or sequence of instructions (collectively referred to as “computer programs”). The computer programs typically comprise one or more instructions (e.g., instructions 2104, 2108, 2128) set at various times in various memory and storage devices in a computing device. When read and executed by the one or more processors 2102, the instruction(s) cause the computing system 2100 to perform operations to execute elements involving the various aspects of the disclosure.

Moreover, while embodiments have been described in the context of fully functioning computing devices, those skilled in the art will appreciate that the various embodiments are capable of being distributed as a program product in a variety of forms. The disclosure applies regardless of the particular type of machine or computer-readable media used to actually effect the distribution.

Further examples of machine-readable storage media, machine-readable media, or computer-readable media include recordable-type media such as volatile and non-volatile memory devices 2110, floppy and other removable disks, hard disk drives, optical disks (e.g., Compact Disk Read-Only Memory (CD-ROMS), Digital Versatile Disks (DVDs)), and transmission-type media such as digital and analog communication links.

The network adapter 2112 enables the computing system 2100 to mediate data in a network 2114 with an entity that is external to the computing system 2100 through any communication protocol supported by the computing system 2100 and the external entity. The network adapter 2112 can include a network adaptor card, a wireless network interface card, a router, an access point, a wireless router, a switch, a multilayer switch, a protocol converter, a gateway, a bridge, bridge router, a hub, a digital media receiver, and/or a repeater.

The network adapter 2112 may include a firewall that governs and/or manages permission to access/proxy data in a computer network and tracks varying levels of trust between different machines and/or applications. The firewall can be any number of modules having any combination of hardware and/or software components able to enforce a predetermined set of access rights between a particular set of machines and applications, machines and machines, and/or applications (e.g., to regulate the flow of traffic and resource sharing between these entities). The firewall may additionally manage and/or have access to an access control list that details permissions including the access and operation rights of an object by an individual, a machine, and/or an application, and the circumstances under which the permission rights stand.

The techniques introduced here can be implemented by programmable circuitry (e.g., one or more microprocessors), software and/or firmware, special-purpose hardwired (i.e., non-programmable) circuitry, or a combination of such forms. Special-purpose circuitry can be in the form of one or more application-specific integrated circuits (ASICs), programmable logic devices (PLDs), field-programmable gate arrays (FPGAs), etc.

### Remarks

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling those skilled in the relevant art to understand the claimed subject matter, the various embodiments, and the various modifications that are suited to the particular uses contemplated.

Although the Detailed Description describes certain embodiments and the best mode contemplated, the technology can be practiced in many ways no matter how detailed the Detailed Description appears. Embodiments may vary considerably in their implementation details, while still being encompassed by the specification. Particular terminology used when describing certain features or aspects of various embodiments should not be taken to imply that the terminology is being redefined herein to be restricted to any specific characteristics, features, or aspects of the technology with which that terminology is associated. In general, the terms used in the following claims should not be construed to limit the technology to the specific embodiments disclosed in the specification, unless those terms are explicitly defined herein. Accordingly, the actual scope of the technology encompasses not only the disclosed embodiments, but also all equivalent ways of practicing or implementing the embodiments.

The language used in the specification has been principally selected for readability and instructional purposes. It may not have been selected to delineate or circumscribe the subject matter. It is therefore intended that the scope of the technology be limited not by this Detailed Description, but rather by any claims that issue on an application based hereon. Accordingly, the disclosure of various embodiments is intended to be illustrative, but not limiting, of the scope of the technology as set forth in the following claims.

1. A method for implementing a clipboard for a device, the method comprising:
detecting a specific action, performed by a user of the device, on a target item that is displayed on a screen of the device; and
in response to the specific action being detected, displaying a clipboard user interface that is configured to allow the user to drag and drop the target item onto the clipboard user interface so as to indicate an intent of the user to utilize one or more of a plurality of clipboard functions with respect to the target item.

2. The method of claim 1, further comprising:
depending on an exact location where the user drops the item, initiating a select clipboard function, that corresponds to the exact location, with respect to the target item.

3. The method of claim 1, wherein the specific action includes a user interface gesture that simulates a grab of the target item.

4. The method of claim 3, wherein the grab includes a drag of the target item.

5. The method of claim 3, wherein the grab includes a long press on the target item, and wherein the long press includes a press and a hold down that exceeds a predetermined amount of time.

6. The method of claim 1, wherein the clipboard user interface includes a number of clipboard function areas, each clipboard function area corresponding to one clipboard function.

7. The method of claim 6, wherein the number of clipboard function areas are arranged in a radial fashion, extending from a common center.

8. The method of claim 7, wherein the clipboard user interface further includes a main clipboard area that represents a storage space of the clipboard.

9. The method of claim 8, wherein the main clipboard area occupies the common center.

10. The method of claim 6, wherein a given clipboard function area is displayed on the clipboard user interface as an icon that represents the given clipboard function.

11. The method of claim 1, wherein the clipboard functions include a sharing function, the method further comprising:
detecting, based on an exact location where the user drops the target item, whether the intent of the user is to utilize the sharing function; and
in response to detecting the intent to utilize the sharing function, displaying a sharing user interface that includes contact information so as to allow the user to initiate sharing of the target item with one or more contacts displayed on the sharing user interface.

12. The method of claim 1, wherein the clipboard functions include an inline editing function, the method further comprising:
detecting, based on an exact location where the user drops the target item, whether the intent of the user is to utilize the inline editing function; and
in response to detecting the intent to utilize the inline editing function, displaying an inline editing interface that includes an editorial tool so as to allow the user to perform inline editing to the target item.

13. The method of claim 12, wherein which editorial tool is displayed in the inline editing interface changes based on a content type of the target item.

14. The method of claim 12, wherein the target item is an image, and wherein the editorial tool includes a cropping tool.

15. The method of claim 14, wherein the cropping tool includes a stylus that allows the user to remove a portion of the image before the image is added to the clipboard.

16. The method of claim 12, wherein the target item is an audio and/or video recording, and wherein the editorial tool includes a tool to change a length of the recording.

17. The method of claim 1, wherein the target item includes one or more of: an email, a calendar event, a piece of weather information, a three-dimensional item, an audio recording, or a video recording.

18. The method of claim 1, further comprising:
detecting a dock summon command by the user; and
in response to the dock summon command being detected, displaying a dock that includes items that are in the clipboard.

19. The method of claim 18, wherein the dock summon command is a gesture, and wherein the dock is displayed at a location where the gesture is performed by the user.

20. The method of claim 18, wherein the dock summon command is a user selectable gesture.

21. The method of claim 18, wherein the dock summon command is a gesture based on three-fingers sliding toward the same direction.

22. The method of claim 18, further comprising:
detecting a location of a pointing device that is controlled by the user; and
in response to detecting that the location of the pointing device is over a given item displayed in the dock, displaying a menu of functions associated with the given item.

23. The method of claim 18, wherein the items displayed in the dock change based on a type of an application on which the user initiates the dock summon command.

24. The method of claim 18, further comprising:
detecting that the user drags the dock; and
relocating the dock to a location where the user drops the dock.

25. The method of claim 18, wherein the dock further includes a visual indicium that represents an annotation function, the method further comprising:
detecting that the user selects the annotation function; and
displaying a stylus so as to allow the user to annotate one or more items in the clipboard.

26. The method of claim 1, further comprising:
automatically receiving, based on a user configuration and from a networked server, data representing content of interest of the user; and
including the content of interest of the user in the clipboard.

27. The method of claim 1, further comprising:
synchronizing, based on a user configuration, the clipboard with another clipboard that belongs to another user.

28. The method of claim 1, wherein the device is a computing device that includes telephony functionality, and wherein the screen of the device includes a touchscreen display.

29. A device comprising:
a processor; and
a memory having instructions stored thereon that, when executed by the processor, case the device to:
detect a specific action, performed by a user of the device, on a target item that is displayed on a screen of the device; and
in response to the specific action being detected, display a clipboard user interface that is configured to allow the user to drag and drop the target item onto the clipboard user interface so as to indicate an intent of the user to utilize one or more of a plurality of clipboard functions with respect to the target item.

30. A non-transitory computer-readable medium containing instructions, execution of which in a computer system causes the computer system to:
detect a specific action, performed by a user of the device, on a target item that is displayed on a screen of the device; and
in response to the specific action being detected, display a clipboard user interface that is configured to allow the user to drag and drop the target item onto the clipboard user interface so as to indicate an intent of the user to utilize one or more of a plurality of clipboard functions with respect to the target item.
